(19) United States
(12) Patent Application Publication
(10) Pub. No.: US 2016/0255160 A1
(43) Pub. Date: Sep. 1, 2016

(54) METHOD AND SYSTEM FOR DETERMINING PRINTER LOCATION ON A MAP

(71) Applicant: KONICA MINOLTA LABORATORY U.S.A. INC., San Mateo, CA (US)

(72) Inventor: Shaun PINNEY, Fremont, CA (US)

(73) Assignee: KONICA MINOLTA LABORATORY U.S.A., INC., San Mateo, CA (US)

(21) Appl. No.: 14/633,838

(22) Filed: Feb. 27, 2015

(51) Int. Cl. H04L 29/08; H04L 29/06; H04L 29/12; H04N 1/00

(52) U.S. Cl. CPC H04L 67/18; H04N 1/00244; H04L 67/42; H04L 61/2007

(57) ABSTRACT

A method is disclosed for determining a physical location of a device, the method comprising: attaching a device to a network switch, the network switch configured to connect the device to a network connection; sending location information from the network switch to the device; sending a discovery request from a client device to the device; obtaining the location information from the device on the client device; sending the location information from the client device to a server to obtain a physical location of the device, wherein the server hosts a location database for a plurality of network switches in the network connection; determining the physical location of the device using the location database hosted on the server; sending the physical location of the device from the server to the client device; and displaying the physical location of the device on the client device.

### FIELD OF THE INVENTION

The present disclosure relates to a method and system for determining a physical location on a map, and more particularly, to a method and system for determining a physical location of a multifunction printer device or printer using discovery protocols and physical locations of network switches in communication to the multifunction printer device or printer.

### BACKGROUND OF THE INVENTION

Printing a document using a network printer can require users to identify available printers, select a desired printer, send a print job, and retrieve the printed sheets. To retrieve the printed sheets, the user generally needs to know the physical location of the selected network printer. Additionally, users may desire to know the physical location of a printer to assist in selecting an appropriate printer. However, it remains difficult for users to easily determine the physical location of available network printers.

Commonly, users are provided with only the IP address or network name of available network printers and no physical location is provided. The method of determining printer locations then becomes a manual, and sometimes time consuming, user task where asking around or physically searching for printers becomes necessary. New users and visitors may easily find themselves in such a position, as well as existing users who may find that their usual printer is unavailable due to an error and suddenly need to print on an unfamiliar printer.

In some cases, an administrator may manually input a fixed physical location into a network printer to assist (for example, “Meeting Room #5”) and this information may then be retrieved by users over the network. However, this approach is error prone since the location information instantly becomes out-of-date when the printer is moved to a new location. To avoid out-of-date data, administrators can be left with the manual maintenance task of keeping the location information in sync with the actual physical location when each printer installation/replacement/move occurs. It can be appreciated that, in addition to increasing the administrator workload, the manual nature of the task may easily result in out-of-date location information being provided regardless of administrator efforts. For example, when printers are moved without administrator notification there is no opportunity to update the location information. Administrators may also find a wide variety of printers from different vendors with different methods to manually input physical locations. The difficulty of finding the correct procedure for a given printer also increases the administrative difficulty of manually managing location information in a heterogeneous printing environment.

Known methods to determine physical location, such as a global position system (GPS), do not provide adequate solutions. For printers without built-in GPS support, additional cost can be required for GPS transceivers and additional administrative effort and time is needed to install, track, and maintain the new GPS units. In addition, some printers may not have the ability to support installing external GPS hardware such that these devices would not be covered.

In addition, printers with internal or external GPS capabilities may fail to function reliably in environments where required signals are unavailable due to security concerns or in locations/buildings with inadequate or spotty signal reception. GPS location information also has variable accuracy and may give different results at different times, so consistent and accurate vertical and horizontal location determination with GPS may be difficult to achieve.

### SUMMARY OF THE INVENTION

In consideration of the above issues, it would be desirable to have a method and system that allows users to easily obtain up-to-date location information of nearby network printers. The method used can help automatically ensure physical location information is kept up-to-date even as printers and clients and/or users are moved to new physical locations, and wherein the location information is stored on and retrieved directly from devices rather than a server.

In accordance with an exemplary embodiment, a method is disclosed for determining a physical location of a device, the method comprising: attaching a device to a network switch, the network switch configured to connect the device to a network connection; sending location information from the network switch to the device; sending a discovery request from a client device to the device; obtaining the location information from the device on the client device; sending the location information from the client device to a server to obtain a physical location of the device, wherein the server hosts a location database for a plurality of network switches in the network connection; determining the physical location of the device using the location database hosted on the server; sending the physical location of the device from the server to the client device; and displaying the physical location of the device on the client device

In accordance with an exemplary embodiment, a non-transitory computer readable medium containing a computer program having computer readable code embodied to carry out a method for determining a physical location of a device is disclosed, the method comprising: attaching a device to a network switch, the network switch configured to connect the device to a network connection; sending location information from the network switch to the device; sending a discovery request from a client device to the device; obtaining the location information from the device on the client device; sending the location information from the client device to a server to obtain a physical location of the device, wherein the server hosts a location database for a plurality of network switches in the network connection; determining the physical location of the device using the location database hosted on the server; sending the physical location of the device from the server to the client device; and displaying the physical location of the device on the client device.

In accordance with an exemplary embodiment, a system is disclosed for determining a location of a device, the system comprising: a network connection; at least one network switch connected to the network connection; at least one device attached to the at least one network switch, the at least one network switch configured to connect the device to the network connection, and wherein the at least one network switch sends location information to the at least one device; a client device connected to the network connection, the client device configured to send a discovery request to the at least one device, and wherein the client device obtains location information from the at least one device; and a server connected to the network connection, wherein the server receives the location information from the client device, and determines a physical location of the device from a location database for a plurality of network switches in the network connection, and which is displayed on the client device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for determining printer location on a map in accordance with an exemplary embodiment.

FIG. 2 is an illustration of a map showing a printer location in accordance with an exemplary embodiment.

FIG. 3 is a flow chart showing a method for determining printer location on a map in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

In light of the preceding, it can be appreciated that an automated printer location solution is desirable and wherein the method and system is capable of reliably determining up-to-date physical locations in a wide variety of environments for a large variety of multifunction printer (MFP) or printers without increasing system cost and requiring minimal administrator maintenance.

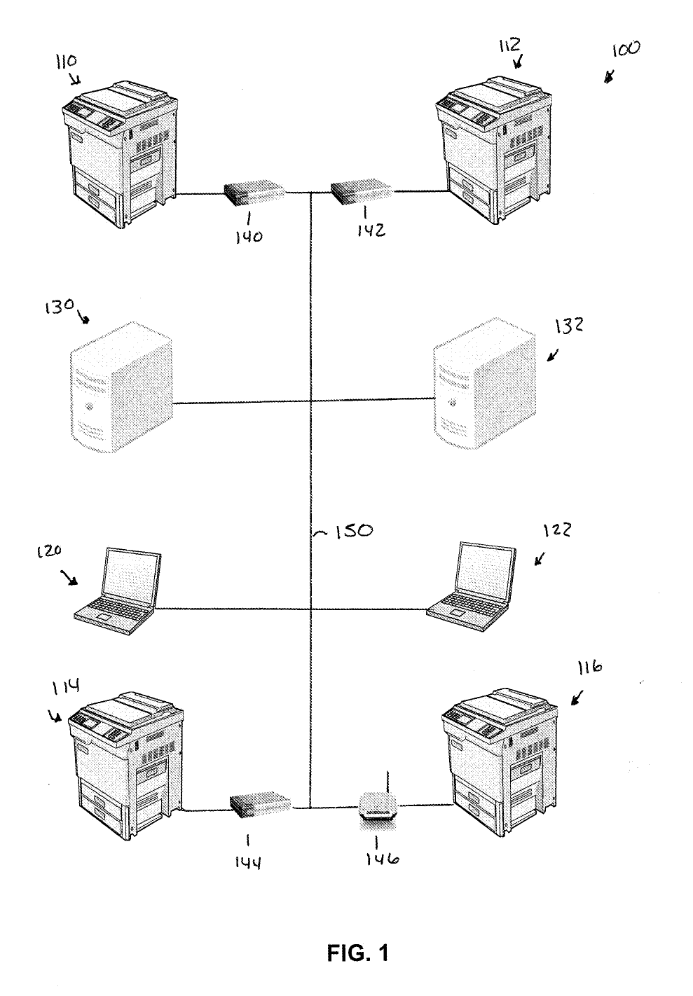

FIG. 1 is an illustration of a network diagram or system 100 for generating determining a printer location on a map in accordance with an exemplary embodiment. As shown in FIG. 1, the system 100 includes one or more multifunction printer devices (MFP) or printers 110, 112, 114, 116, (hereinafter “MFP” or “printer”) which can be, for example, image forming apparatuses and/or printers, one or more clients or client devices 120, 122, at least one server 130, at least one printer server 132, one or more network switches 140, 142, 144, and at least one wireless router 146. Although, the system 100 is disclosed in connection with a MFP or printer 110, 112, 114, 116, the system and method as disclosed can be used with any device capable of obtaining location information from attached network switches to determine the location of the device. For example, the method and system as disclosed can be used, for example, with personal computers, laptops, cellphones, tablets, kiosks, wireless access points, and network attached storage devices.

In accordance with an exemplary embodiment, the one or more multifunction printer devices (MFP) 110, 112, 114, 116, the one or more clients 120, 122, the at least one server 130, the at least one printer server 132, the one or more data switches, 140, 142, 144, and the at least one wireless router 146 are preferably connected via an Internet or network connection 150, such as a LAN (Local Area Network) or WAN (Wide Area Network).

In accordance with an exemplary embodiment, the one or more multi-functional printer devices (MFP) or printers 110, 112, 114, 116 are connected to the one or more client devices 120, 122. The one or more client devices 120, 122 can be configured to submit print jobs to the multifunction printers or printers 110, 112, 114, 116 by transmitting data representing the documents to be printed and information describing the print job. The multifunction printer or printer 110, 112, 114, 116 can include a printer controller (or firmware), a memory section preferably in the form of a hard disk drive (HDD), an image processing section (or data dispatcher), a print engine, and an input/output (I/O) section.

The controller of the multifunction printer or printer 110, 112, 114, 116 can include a central processing unit (CPU), a random access memory (RAM), and a read only memory (ROM). The central processing unit can be configured to execute a sequence of stored instructions (e.g., a computer program). It can be appreciated that the controller also includes an operating system (OS), which acts as an intermediary between the software programs and hardware components within the multifunction printer or printer 110, 112, 114, 116. The operating system (OS) manages the computer hardware and provides common services for efficient execution of various application software. In accordance with an exemplary embodiment, the controller processes the data and job information received from the one or more client devices 120, 122 and generates a print image.

The image processing section carries out image processing under the control of the controller, and sends the processed print image data to the print engine. The image processing section is preferably capable of processing multiple print jobs or sub-jobs in parallel and independently. For instance, the image processing section can include a CPU that contains multiple cores therein to realize the multiple RIP modules explained in detail later. The CPU used constituting a part of the controller can be commonly used for the image processing section. The print engine forms an image on a recording sheet based on the image data sent from the image processing section. The I/O section performs data transfer with the one or more client devices 120, 122. The controller is programmed to process data and control various other components of the multifunction printer or printer 110, 112, 114, 116 to carry out the various methods described herein. The hard disk drive (HDD) or storage device stores digital data and/or software programs for recall by the controller. In accordance with an exemplary embodiment, the digital data includes resources, which can include graphics/images, logos, form overlays, fonts, etc.

Examples of an multifunction printer (MFP) or printer 110, 112, 114, 116 consistent with exemplary embodiments include, but are not limited to, a laser beam printer (LBP), a multifunction laser beam printer including copy function, an ink jet printer (IJP), a thermal printer (for example, a dye sublimation printer) and a silver halide printer. For example, the multifunction printer or printer 110, 112, 114, 116 can be a color printer or a black and white (B/W) printer.

In accordance with an exemplary embodiment, each of the one or more client devices 120, 122 can include a processor or central processing unit (CPU), and one or more memories for storing software programs and data (such as files to be printed). The processor or CPU carries out the instructions of a computer program, which operates and/or controls at least a portion of the functionality of the client devices 120, 122. Each of the client devices 120, 122, can also include an operating system (OS), which manages the computer hardware and provides common services for efficient execution of various software programs. For example, the software programs can include application software and printer driver software. The printer driver software controls the multifunction printer or printer 110, 112, 114, 116 connected with the client devices 120, 122 in which the printer driver software is installed. In certain embodiments, the printer driver software produces a print job and/or document based on an image and/or document data. In addition, the printer driver software can control transmission of the print job from the client device 120, 122 to the multifunction printer or printer 110, 112, 114, 116.

Each of the one or more client devices 120, 122 can also include a display in the form of a graphical user interface. In accordance with an exemplary embodiment, the printer driver software generates a printer driver user interface or graphical user interface in which the user of the one or more client devices 120, 122 can provide instructions to the multifunction printer or printer 110, 112, 114, 116. In addition, each of the client devices 120, 122 can be configured to receive e-mails, for example, from the multifunction printer or printer 110, 112, 114, 116 via the network connection 150 and/or wireless technology including but not limited to radio frequency (RF) and/or infrared (IR) transmission. Examples of client devices 102, 104, 108 can include and are not limited to personal computers and/or personal digital assistants (PDAs).

In accordance with an exemplary embodiment, the at least one server 130 can include a processor or central processing unit (CPU), and one or more memories for storing software programs and data. The processor or CPU carries out the instructions of a computer program, which operates and/or controls at least a portion of the functionality of the at least one server 130. The server 130 can also include an operating system (OS), which manages the computer hardware and provides common services for efficient execution of various software programs.

In accordance with an exemplary embodiment, the one or more network switches 140 can include, for example, an Ethernet switch, for example, an Ethernet switch having Link Layer Discovery Protocol (LLDP), a gateway, a router, and the like.

Examples of the networks 150 consistent with embodiments include, but are not limited to, the Internet, an intranet, a local area network (LAN) and a wide area network (WAN). Alternatively, the Internet or network connection 120, which connects the multifunction printer or printer 110, 112, 114, 116, the one or more client devices 120, 122 can be a wire (or cable) and/or wireless technology including but not limited to radio frequency (RF) and/or infrared (IR) transmission.

In accordance with an exemplary embodiment, a system and method for determining a current or up-to-date location of printer is disclosed, which can allow users to quickly and easily utilize new network printers and existing network printers, which have moved and/or changed to new locations. In addition, the location information can also help new and visiting users adapt to both the new network and physical printing environment.

In accordance with an exemplary embodiment, location information can be automatically updated as printers are added or moved to simplify administration tasks by ensuring up-to-date location information can be available without manual intervention from administrators. In addition, the number of printers can be scaled up without requiring additional administrative effort to maintain up-to-date location information.

In addition, storing location information on printers allows location information to be retrieved directly from printers without relying on a server to supply location information.

Users gain increased reliability by being able to retrieve location information directly from individual devices without contacting a server, which may be down. For example, even if a printer goes down the location information from other printers can still be available.

Administrators can also benefit from efficient network usage since there is no need to send updated location information to a server each time a printer's physical location changes.

In accordance with an exemplary embodiment, administrators can enjoy simplified integration with existing network infrastructures and printers, since many technologies, which can be used are readily available and deployed (for example, Bonjour/mDNS/WS-Discovery/SLP/LLTD/etc., LLDP/CDP/etc., SNMP). In addition, the use of standard technologies can enable vendor-interoperability by allowing printer location to be determined in heterogeneous printing and network switch environments. In accordance with an exemplary embodiment, any discovery protocol can be used, which can discover an IP address of a device and/or machine including protocols that can determine services supported by a device, for example, print support, scan support, and the like.

The system and methods as disclosed, can also be utilized in existing network hardware to determine physical locations, which can avoid increasing per-device hardware costs, for example, associated with GPS.

Determining a printer's physical location without relying upon non-network signals (for example, GPS) increases the number of environments, which can support printer location services. In addition, the system and methods as disclosed herein can return high-accuracy location information, which can simplify the task of physically locating printers. For example, compared with GPS where accuracy ranges can vary over time.

In addition, the system and method as disclosed can supplying consistent location information for the same MFP or printer 110, 112, 114, 116 can increase user confidence in physically locating printers. For example, compared with GPS where location information can change over time even when printers are not moved.

In accordance with an exemplary embodiment, the one or more multifunction printers (MFP) or printers 110, 112, 114, 116 can receive location information from network switches 140, 142, 144 (for example, an Ethernet switch) after they are connected. In accordance with an exemplary embodiment, network switches 140, 142, 144 can communicate this location information to printers using network protocols such as LLDP/CDP/etc. As a printer 110, 112, 114, 116 moves and is connected to new Ethernet switches and ports 140, 142, 144, the MFP or printer 110, 112, 114, 116 will receive new location information. In accordance with an exemplary embodiment, in this way, the location information can be kept up-to-date, ever if the MFP or printer 110, 112, 114, 116 is moved. MFP or printers 110, 112, 114, 116 can store the location information internally for future retrieval by a remote system. In accordance with an exemplary embodiment, the MFP or printer 110, 112, 114, 116 can make this location information available to remote systems via discovery protocols (e.g. Bonjour) or by direct means (e.g. SNMP).

For example, an Ethernet switch supporting LLDP can send a Chassis ID and Port ID to the printer after the printer is connected. The Chassis ID and Port ID uniquely identify the Ethernet switch and a port on the switch. Moving the MFP or printer 110, 112, 114, 116 and plugging it into another LLDP-capable Ethernet switch and port will send a different Chassis ID and Port ID to the printer 110, 112, 114, 116. In this way, the location information changes as the printers 110, 112, 114, 116 are moved. In both cases, the Chassis ID and Port ID are stored by the printer 110, 112, 114, 116 using available storage. In accordance with an exemplary embodiment, the network switch 140, 142, 144, can be configured with one or more network switch ports, and wherein each of the one or more network switch ports has a unique port ID (or identifier), which is discoverable in accordance with a discovery protocol, for example, CDP.

Once a printer 110, 112, 114, 116 has obtained its location information then remote systems may obtain printer location information. A remote system will first obtain a printer's IP address. A printer's IP address may be obtained by static configuration on the remote system (for example, manually input) or via a discovery protocol.

In accordance with an exemplary embodiment, discovery protocols may include Bonjour, mDNS, WS-Discovery, SLP, LLTD, and/or ARP. For example, once a printer's IP address is known, the remote system may then directly query the printer for its location information. For example, in accordance with an exemplary embodiment, SNMP can allow for this type of query where the location information is addressable by selecting a specific object identifier (01D). In this way, location information may be obtained for both discovered and statically configured printers. Alternatively, printers may choose to send location information as part of a discovery protocol. For example, Bonjour allows for this style of query where multiple types of information may be returned in addition to the printer's IP address.

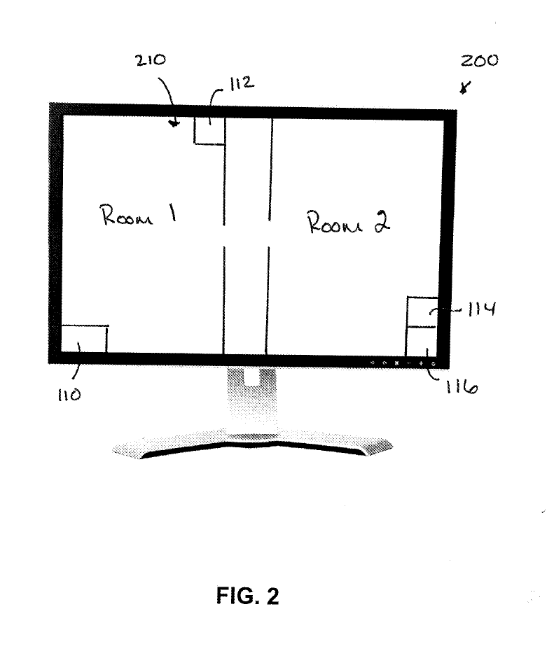

To assist in presenting location information in a convenient manner to users, users may additionally send received location information to the at least one server 130, which converts the location information into a location text string (for example, “Meeting Room #5), map image with image location information (for example, Floor #2 map image with pixel location of Meeting Room #5 location), map image with printer icon (for example, Floor #2 map image with printer icon over Meeting Room #5 location), hyperlink to map image with image location, etc. or other representation. As shown in FIG. 2, the at least one server 130 will send the location representation back to the client or client device 120, 122 where a map 210 can be displayed and which identifies the location of the at least one MFP or printer 110, 112, 114, 116. For example, in accordance with an exemplary embodiment, the location of the at least one MFP or printer 110, 112, 114, 116, can be displayed on the graphical user interface (GUI) 200 on the client device 120, 122. In addition, the system and method as disclosed can be part of a cloud-based location solution, which can integrate with an existing corporate intranet framework, for example, SharePoint.

In accordance with an exemplary embodiment, for example, in the case where the server sends a hyperlinked map image with image location information, the client device (or user machine) 120, 122 may download the map image using the hyperlink, then use the image location information to overlay a printer icon over the map image at the appropriate image location. In accordance with an exemplary embodiment, the client device 120, 122 may cache the map image and image location information to reduce the need to contact the server 130 again to display the printer location at a future time. This also allows previously obtained locations to be provided to client devices and/or users 120, 122, if the server 130 is down. Additionally, the printer icon may provide other information about the printer's name, IP address, and/or state, for example, “ok” or “error.”

In accordance with an exemplary embodiment, a tool is disclosed which allows administrators to create a database to allow conversion between location information retrieved from the printer and location text strings, map images, image location information, or other location representations. For example, administrators may manually input location information into the database or obtain location information automatically by connecting to a network switch port in each office at each network port location. Administrators may then be presented with an input dialog, which prompts them to select the associated map image or hyperlink to a map image. Additionally, the tools may prompt administrators to click a point or select an area on the map image corresponding to the location information. In accordance with an exemplary embodiment, the image location information on the map image can be associated with the printer's location information. Administrators can use this tool to create the initial database and can use the tool to add, update, and/or remove entries as needed due to changes in how network ports are connected to a building's port outlets or as network switches or ports are added, changed, and/or removed. In accordance with an exemplary embodiment, the database may be exported from the tool and transferred to the at least one server 130. The tool may also allow the server's database to be created, edited, and/or deleted remotely. In accordance with an exemplary embodiment, authentication can be required before allowing creation/editing/removal of the server's database to help ensure only authorized users can make changes.

In accordance with an exemplary embodiment, the methods disclosed herein can be applied to devices other than MFPs and/or printers. For example, the system and methods as disclosed, can be applied to any device capable of obtaining location information from attached network switches, and can follow a similar method to allow users to determine the location of the device. For example, the device could include PCs, laptops, cellphones, tablets, kiosks, wireless access points, network attached storage, and IP phones.

In accordance with an exemplary embodiment, the client device 120, 122 can also contain location information. For example, the location information of the client device 120, 122, can be used in a similar way to display the location of the user machine as well. For example, the client device 120, 122 may obtain its location information and display a map image with a PC icon displayed at the client device's position. In addition, the same map image may also display printer icons corresponding to printer locations on the same map. This feature may help users visualize where a printer 110, 112, 114, 116 is relative to their current position and assist in navigation.

In accordance with an exemplary embodiment for wireless printers, rather than connecting to a network switch 140, 142, 144, the wireless printer can be connected to a wireless access point 146. In this environment, the wireless printer 116 will receive its location information from the connected wireless access point and know which wireless access point that the MFP or printer 116 is connected. With this information, the client device 120, 122 can obtain location information from the wireless printer in the same way as a wired printer connected to a network switch 140, 142, 144. As an extension, the wireless printer 116 can also supply the wireless printer's range from the access point along with its location information to allow users to more accurately determine the location of the printer. For example, this range information may be directly supplied by the wireless printer 116 or lower level metrics such as received signal strength can be supplied to allow the remote machine to attempt to calculate the range. Thus, in the case where the client device (or user) 120, 122 knows the location of the wireless access point connected to the MFP or printer 116, the client device (or user) 120, 122 can also know the appropriate wireless range to search to locate the MFP or printer 116

In accordance with an exemplary embodiment, the wireless range can include a specific distance, for example, 10 meters away, or a distance range, for example, within a specific distance, for example, within 10 meters. In accordance with an exemplary embodiment, the wireless printer 116 and/or wireless access point 146 can be configured to send information that can be used to calculate a range, for example, the wireless printer 116 and/or wireless access point 146 can send wife signal strength as X dbm, which can be used to estimate a specific distance and/or a distance range within which the wireless printer 116 is located.

In the case where the user does not know the location of the wireless access point connected to the MFP or printer 116, and the wireless access point 146 is connected to a network switch 140, 142, 144, then the user can also determine the location of the wireless access point similar approaches and technologies. For example, the client device (or user) 120, 122 can use network discovery to obtain the IP address of the wireless printer 116 and the range of the wireless printer 116 from the connected access point, the client device (or user) 120, 122 can then use SNMP to obtain the IP address of the connected wireless access point 146 from the wireless printer 116 then the client device (or user) 120, 122 can use the wireless access point's IP address to obtain its location information using SNMP. Variations include obtaining the MAC address from the wireless printer 116 and converting the MAC address to an IP address. In accordance with an exemplary embodiment, network discovery may be substituted for SNMP.

In accordance with an exemplary embodiment, the system can be configured such that a distinct step can be performed to determine if the printer 110, 112, 114, 116 is wired or wireless, and ascertaining if the printer 110, 112, 114, 116 can supply additional range information to assist in determining the physical location of the printer 110, 112, 114, 116. The above also applies when wireless access points 146 are connected to other wireless access points or with ad-hoc wireless networking.

In accordance with an exemplary embodiment, if a printer 110, 112, 114, 116 is not attached to a network switch 140, 142, 144, but is directly attached to a print server 132, and the print server 132 is attached to a network switch 140, 142, 144 then the print server 132 may act as a proxy for the printer 110, 112, 114, 116. In accordance with an exemplary embodiment, a print server 132 can respond on the network in the same way as a MFP or printer 110, 112, 114, 116 would respond if it were directly attached. Thus, the location information of print server 132 may be used as a substitute for the non-networked printer.

In accordance with an exemplary embodiment, for example, if a printer is physically attached to a print server 132 over a wired connection (for example, USB, parallel port, Ethernet, etc.) and the print server 132 is attached to a network switch 140, 142, 144, then the print server 132 will obtain location information from its attached network switch 140, 142, 144. Client device (or users) 120, 122 may locate the print server 132 by static configuration or discovery protocols, and obtain the print server's location information from a discovery protocol or directly using SNMP over the print server's IP address. The user can interpret the print server's location information to be equivalent to the printer's location since it is directly attached.

In the event a MFP or printer 110, 112, 114, 116 is directly connected to a print server 132 over a wireless connection, for example, WiFi, Bluetooth, etc., then the print server 132 may choose to supply additional location information to assist with locating the MFP or printer 110, 112, 114, 116. The information may include the range of the device relative to the print server 132 or lower level metrics such as received signal strength to allow the remote machine to attempt to calculate the range. As an extension, the additional location information may come from the device itself, or intermediate devices (for example, repeaters, gateways, etc.) between the client device 120, 122 and the device.

For security or business reasons, it may be desirable to prevent location information from being available on some devices. In these cases, administrators may prefer to configure network switches to avoid sending location information to certain connected devices. For example, LLDP may be disabled on a particular switch and port. However, when devices are moved to other locations they may still obtain and supply their location information. To address this issue, devices themselves may be configured to disable their location information storage and/or transmission capability.

In other cases, an administrator may desire that only certain privileged users have access to location information while non-privileged users cannot obtain location information. To address this issue, we allow that authentication may be required by SNMP and/or discovery protocols prior to a device transmitting its location information to a user. Additionally, we also allow that network switches may choose not to supply location information to non-authenticated devices. For example, devices may only transmit location information to devices, which have first authenticated using technologies such as, for example, IEEE 802.1X.

In the above descriptions, for cases where users and devices are communicating directly to obtain discovery and location information, the system and method can allow be configured that servers may also be inserted in between client device or users 120, 122 and the printers (or devices) 110, 112, 114, 116. For example, some discovery protocols (for example, Bonjour) will advertise a device's IP address when the device is powered and attached to the network. In accordance with an exemplary embodiment, servers 130 may be setup to cache this information (for example, LDAP) to reduce additional network traffic to the device. In this case, the client device or users 120, 122 may choose to contact the server 130 rather than the MFP (or device) 110, 112, 114, 116 to determine printer IP addresses. In addition, location information may be sent from a MFP (or device) 110, 112, 114, 116 to a server 130 via SNMP or discovery protocols or the server 130 may request location information from devices via SNMP or discovery protocols so that users can contact the server 130 to obtain location information. In accordance with an exemplary embodiment, these configurations are allowed and supported although not required. In this way, administrative setup time can be minimized since server technologies may be used.

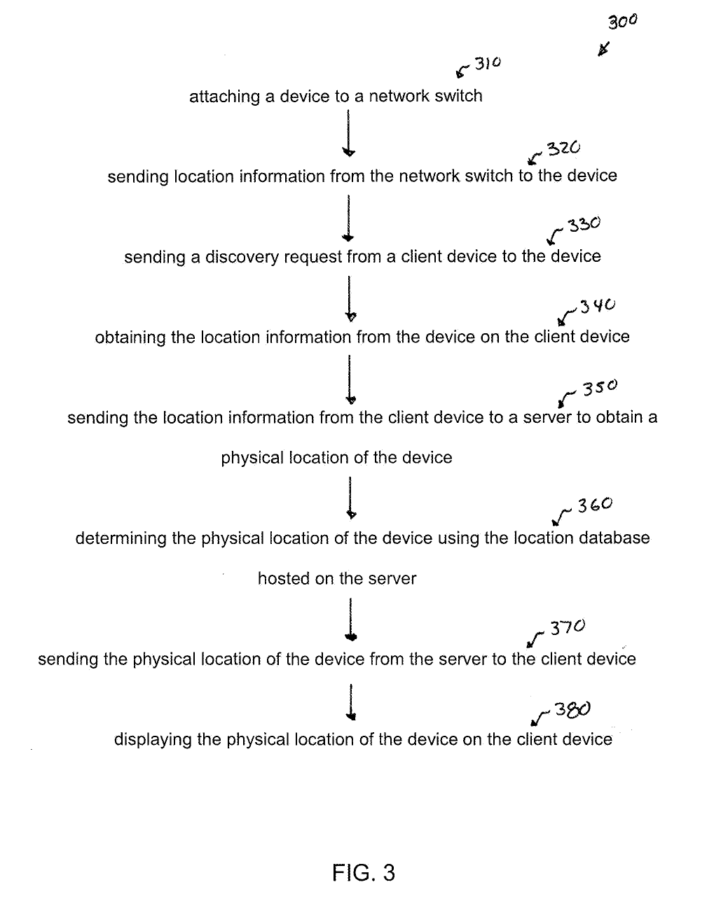

FIG. 3 is a flow chart 300 showing a method for determining printer location on a map in accordance with an exemplary embodiment. As shown in FIG. 3, in step 310, a device is attached to a network switch, the network switch being configured to connect the device to a network connection. In step 320, location information is sent from the network switch to the device. In step 330, a discovery request is sent from a client device to the device. In step 340, the location information is obtained from the device on the client device. In step 350, the location information is sent from the client device to a server to obtain a physical location of the device, wherein the server hosts a location database for a plurality of network switches in the network connection. In step 360, the physical location of the device can be determined using the location database hosted on the server. In step 370, the physical location of the device is sent from the server to the client device. In step 380, the physical location of the device is displayed on the client device.

In accordance with an exemplary embodiment, a non-transitory computer readable medium containing a computer program having computer readable code embodied to carry out a method for determining a physical location of a device is disclosed, the method comprising: attaching a device to a network switch, the network switch configured to connect the device to a network connection; sending location information from the network switch to the device; sending a discovery request from a client device to the device; obtaining the location information from the device on the client device; sending the location information from the client device to a server to obtain a physical location of the device, wherein the server hosts a location database for a plurality of network switches in the network connection; determining the physical location of the device using the location database hosted on the server; sending the physical location of the device from the server to the client.

The computer readable recording medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for determining a physical location of a device, the method comprising:
attaching a device to a network switch, the network switch configured to connect the device to a network connection;
sending location information from the network switch to the device;
sending a discovery request from a client device to the device;
obtaining the location information from the device on the client device;
sending the location information from the client device to a server to obtain a physical location of the device, wherein the server hosts a location database for a plurality of network switches in the network connection;
determining the physical location of the device using the location database hosted on the server;
sending the physical location of the device from the server to the client device; and
displaying the physical location of the device on the client device.

2. The method of claim 1, wherein the discovery request is a discovery protocol request, which is selected from one of the following:
Bonjour, mDNS, WS-Discovery, SLP, LLTD, and/or ARP.

3. The method of claim 2, comprising:
obtaining the location information from the device along with or after obtaining an IP address of the device.

4. The method of claim 1, wherein the discovery request comprises:
using a static configuration to obtain an IP address of the device.

5. The method of claim 1, wherein the network switch is an Ethernet switch; and
sending a unique port ID to the device after the device is connected to the Ethernet switch.

6. The method of claim 1, wherein each of the plurality of networks switches has one or more network switch ports having a unique location; and
manually inputting location information of each of the one or more network switch ports into the database.

7. The method of claim 1, wherein the network switch is a wireless access point, and
sending a unique port ID to the device after the device is connected to the wireless access point.

8. The method of claim 7, comprising:
providing a range from the access point in addition to the location of the access point to the client device.

9. The method of claim 1, wherein the device is a non-networked printer, and the non-networked printer is attached to a print server connected to the network switch; and;
sending location information of the print server for a location of the non-networked printer.

10. The method of claim 1, comprising:
showing the physical location of the device on an interactive map on a graphical user interface of the client device.

11. A non-transitory computer readable medium containing a computer program having computer readable code embodied to carry out a method for determining a physical location of a device, the method comprising:
attaching a device to a network switch, the network switch configured to connect the device to a network connection;
sending location information from the network switch to the device;
sending a discovery request from a client device to the device;
obtaining the location information from the device on the client device;
sending the location information from the client device to a server to obtain a physical location of the device, wherein the server hosts a location database for a plurality of network switches in the network connection;
determining the physical location of the device using the location database hosted on the server;
sending the physical location of the device from the server to the client device; and
displaying the physical location of the device on the client device.

12. The non-transitory computer readable medium of claim 11, wherein the discovery request is a discovery protocol request, which is selected from one of the following:
Bonjour, mDNS, WS-Discovery, SLP, LLTD, and/or ARP.

13. The non-transitory computer readable medium of claim 12, comprising:
obtaining the location information from the device along with or after obtaining an IP address of the device.

14. The non-transitory computer readable medium of claim 11, wherein the discovery request comprises:
using a static configuration to obtain an IP address of the device.

15. A system for determining a location of a device, the system comprising:
a network connection;
at least one network switch connected to the network connection;
at least one device attached to the at least one network switch, the at least one network switch configured to connect the device to the network connection, and wherein the at least one network switch sends location information to the at least one device;
a client device connected to the network connection, the client device configured to send a discovery request to the at least one device, and wherein the client device obtains location information from the at least one device; and
a server connected to the network connection, wherein the server receives the location information from the client device, and determines a physical location of the device from a location database for a plurality of network switches in the network connection, and which is displayed on the client device.

16. The system of claim 15, wherein the discovery request is a discovery protocol request, which is selected from one of the following:
Bonjour, mDNS, WS-Discovery, SLP, LLTD, and/or ARP.

17. The system of claim 15, wherein each of the plurality of networks switches has one or more network switch ports having a unique location, and location information of each of the one or more network switch ports is manually input into the database.

18. The system of claim 15, wherein the network switch is a wireless access point, and wherein the access point provides a range in addition to the location of the access point to the client device.

19. The system of claim 15, wherein the physical location of the device is shown on an interactive map on a graphical user interface of the client device.

20. The system of claim 15, wherein the at least one device is one of a plurality of networked multifunction printers, and the networking device is an Ethernet switch.
